(19) United States
(12) Patent Application Publication
(10) Pub. No.: US 2003/0116368 A1
(43) Pub. Date: Jun. 26, 2003

(54) Accessory drive for vehicle with hybrid drive system

(76) Inventors: James R. Winkelman, Bloomfield Hills, MI (US); William P. Donohue, Milford, MI (US); Kanwal Bhatia, Troy, MI (US); Jeffrey J. Brautigan, Livonia, MI (US); Marci Smith, Ann Arbor, MI (US); Greg J. Smith, Canton, MI (US); Zheng Lou, Plymouth, MI (US); Mathew Breton, Westland, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/033,971

(22) Filed: Dec. 20, 2001

(51) Int. Cl. B60K 6/00

(52) U.S. Cl. 180/65.2

(57) ABSTRACT

A vehicle drive system for a hybrid electric vehicle includes an engine, which includes a crankshaft assembly, and a motor, which includes a main rotor shaft. A first clutch selectively engages the crankshaft assembly and the main rotor shaft. The vehicle drive system also includes a transmission, which includes an input shaft, and second clutch which selectively engages the main rotor shaft and the transmission input shaft. An accessory drive mechanism is driven by the main rotor shaft and drives a vehicle accessory. The accessory may be an air conditioning compressor and include a clutch coupled between the accessory drive mechanism and the compressor.

### BACKGROUND OF INVENTION

The present invention relates to vehicles with hybrid powertrains and more particularly to hybrid powertrains with accessory drives for vehicle accessories.

Conventional vehicles operate with an internal combustion engine that is always on while the vehicle is being operated. Even when the vehicle is temporarily stopped, the engine continues to run, but is disengaged from the drivetrain by a clutch or torque converter. Such engines are designed not only to propel the vehicle, but also to drive various vehicle accessories. The accessories might include water pumps, air conditioning compressors, vacuum pumps, and power steering pumps. The accessories are typically driven off of a front end accessory drive that is rotationally coupled to the engine crankshaft. With such an arrangement, the accessories are driven the entire time the vehicle is being operated, even when the vehicle is stopped. An accessory that does not need to be run continuously will have its own clutch to disengage it from the accessory drive.

New vehicles are being developed, however, that do not employ just an engine to propel them. Hybrid electric vehicles, in particular, employ both an engine and a motor, with either or both able to propel the vehicle, depending upon the particular driving conditions. In such a hybrid vehicle, then, the engine is not always on during vehicle operation. Consequently, merely connecting the vehicle accessories to a front end accessory drive is no longer adequate.

Some have attempted to solve this problem by adding one or more dedicated motors to power these accessories. However, this extra motor adds to the cost and weight of the vehicle, and also makes packaging all of the components more difficult—especially since both an engine (with fuel system) and a motor (with batteries) must now be packaged in the vehicle.

Thus, it is desirable to have a vehicle with a hybrid powertrain that will adequately power vehicle accessories under the various vehicle driving conditions, including vehicle stopped conditions, with sufficient power, low cost, and minimal required packaging space.

### SUMMARY OF INVENTION

In its embodiments, the present invention contemplates a vehicle drive system that includes an engine having a crankshaft for outputting torque, and a motor/generator having a stator, and a rotor rotationally mounted within the stator, with the rotor including a main rotor shaft. A first clutch is coupled to the crankshaft on a first side and the main rotor shaft on a second side, for selectively coupling the engine crankshaft to the main rotor shaft. There is a transmission, having a main input shaft, and a second clutch coupled to the main rotor shaft on a first side and the transmission main input shaft on a second side, for selectively coupling the main rotor shaft to the transmission input shaft. An accessory drive mechanism is coupled between the main rotor shaft and an accessory input shaft, and a rotationally driven vehicle accessory is coupled to the accessory input shaft.

An advantage of the present invention is that one or more vehicle accessories can be driven while the vehicle is moving or stopped, without requiring an additional dedicated electric motor, to power these accessories.

Another advantage of the present invention is that the engine, motor or both can power one or more vehicle accessories, whether the vehicle is moving or stopped, which can be accomplished whether the transmission is a continuously variable transmission or a more conventional gear driven transmission.

### BRIEF DESCRIPTION OF DRAWINGS

FIG. 1 is a schematic view of a hybrid vehicle drive system in accordance with the present invention; and

FIG. 2 is a view similar to FIG. 1, but illustrating an alternate embodiment of the present invention.

### DETAILED DESCRIPTION

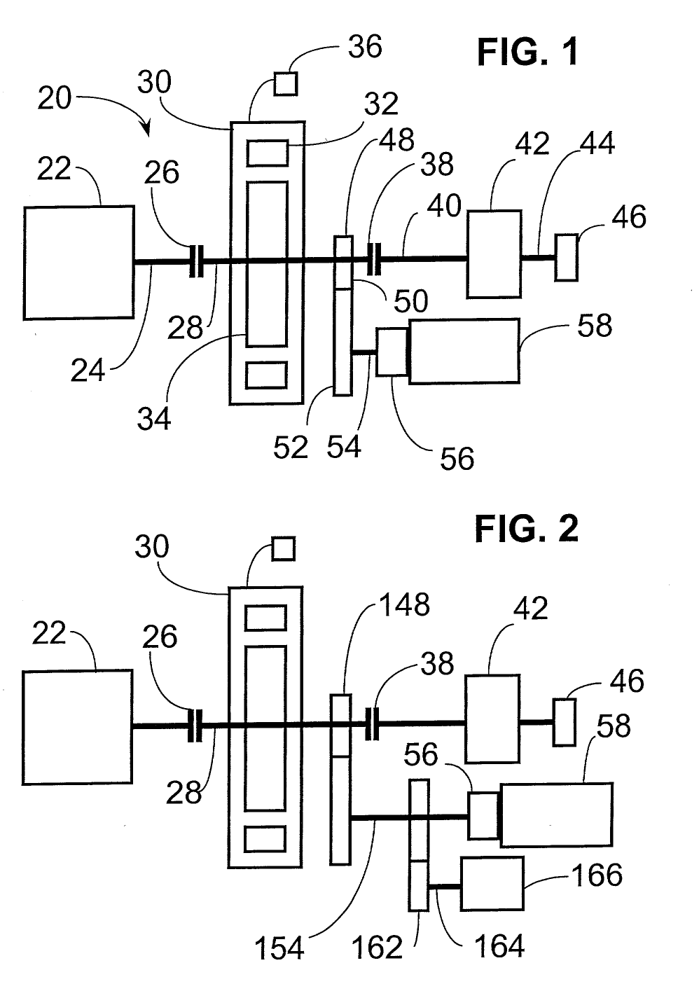

FIG. 1 illustrates a hybrid vehicle drive system 20 according to a first embodiment of the present invention. The drive system 20 includes an internal combustion engine 22, which may be powered by gasoline, diesel fuel, or some other type of fuel source. The engine 22 includes a crankshaft assembly 24 extending therefrom, which is rotationally driven by the engine 22. The crankshaft assembly 24 connects to the torque input side of a first clutch assembly 26. The torque output side of the first clutch assembly 26 connects to a main rotor shaft 28 of a traction motor/generator 30. This first clutch assembly 26 is a type that can be electronically controlled.

The motor 30 includes a stator 32, which is generally fixed relative to the vehicle, and is electrically connected to a battery 36. The motor also includes a rotor 34, which can rotate relative to the stator 32 and is rotationally fixed to the main rotor shaft 28. The main rotor shaft 28 extends outward from the motor 30 and connects to the torque input side of a second clutch assembly 38.

This second clutch assembly 38 is preferably a type that can be electronically controlled, although it may also be a manually controlled clutch. One will note that the main rotor shaft 28 extends outward on both sides of the rotor 34, connecting the output side of the first clutch assembly 26 to the input side of the second clutch assembly 38. The torque output side of the second clutch assembly 38 connects to a main input shaft 40 of a transmission 42. The transmission 42 may be a conventional gear driven type of transmission, or a continuously variable transmission. The transmission 42 includes an output shaft 44, which connects to the rest of a vehicle drivetrain 46. This portion of the drivetrain 46 will vary depending on whether the vehicle is front wheel drive or rear wheel drive, but is generally conventional and so will not be discussed further.

Rotationally coupled to the main rotor shaft 28 is an input member 50 of an accessory drive mechanism 48. This accessory drive mechanism 48 is shown coupled to the main rotor shaft 28 between the motor 30 and the second clutch assembly 38, but it can also be coupled to the shaft 28 between the motor 30 and the first clutch assembly 26, since the same shaft 28 extends outward on both sides of the motor 30. The accessory drive mechanism 48 can be one of several different types of mechanisms that transfer torque and allow for a step-down/step-up in torque/rotational velocity. For example, it can be a set of gears, a pulley-belt assembly (fixed or variable ratio), or a sprocket-chain assembly.

An output member 52 of the accessory drive mechanism 48 is coupled to the input member 50, and connects to an accessory drive input shaft 54, which, in turn, connects to an accessory clutch 56. The clutch 56 connects to the particular vehicle accessory 58 to be driven. The accessory clutch 56 is optional, and depends upon the particular accessory being driven and its desired operating characteristics relative to the vehicle drive system operating characteristics. The accessory can be a water pump, air conditioning compressor, vacuum pump, an air pump, an oil pump, and/or a power steering pump.

For example, the vehicle accessory 58 may be a compressor for a vehicle air conditioning system. Then, depending upon the particular type of transmission 42 employed and the desired operating characteristics for the air conditioning compressor 58, the compressor clutch 56 can be electronically operated to engage and disengaged depending upon the needs of the air conditioning system. Or, on the other hand, if the compressor 58 is a variable capacity compressor that can always be on, it can have no clutch, so long as the transmission 42 is one that allows for the main rotor shaft 28 to run in the same direction, whether the vehicle is moving forwards or backwards. If the transmission 42 is a continuously variable type that will require the main rotor shaft 28 to rotate in one direction when the vehicle is moving forward and the opposite direction when in reverse, then the clutch 56 can be a one-way clutch that only engages when the drive train is driven forward, but slips when the drivetrain is driven in reverse.

The operation of the hybrid drive system 20 and the various ways that it drives the accessory 58 will now be described. When the second clutch 38 is engaged but the first clutch 26 is disengaged, then the motor 30 can drive the transmission 42, which, in turn, will drive the remainder of the vehicle drivetrain 46, propelling the vehicle. The motor 30, then, will also drive the accessory 58 via the accessory drive mechanism 48. When the first clutch 26 and the second clutch 38 are both engaged, the engine 22 and motor 30 can together drive the transmission 42, or the engine 22 can drive the transmission 42 and drive the motor 30, in effect now a generator, charging the vehicle's batteries 36 as the vehicle is propelled. In either case, then, the accessory 58 will be driven at the same time as the motor and/or engine. When the first clutch 26 is engaged and the second clutch 38 is disengaged, then the engine 22 can run and drive the motor (generator) 30 without propelling the vehicle. The accessory 58 is then driven as the motor (generator) 30 is being driven. Also, if so desired, the motor 30 can drive the accessory 58 without propelling the vehicle.

The various options for driving the accessory 58 are particularly important when the accessory 58 is an air conditioning compressor. With the second clutch 38 between the motor 30 and the transmission 42, one can totally disengage the transmission 42 from the motor 30 and engine 22 while at a full stop, such as at a stop light, in a traffic jam, or idling in a parking lot, and keep the motor 30 or engine 22 running to drive the air conditioning compressor 58. This is particularly important in hot climates where one will want the air conditioning system producing cool air, even when the vehicle is stopped.

FIG. 2 illustrates a second embodiment of the invention where two accessories are driven off of the main rotor shaft 28. Elements that are the same as the first embodiment will be designated with the same element numbers, but those that have change or been added will be designated with 100 series numbers. The engine 22, motor 30 and rotor shaft 28, transmission 42, the first and second clutches 36, 38, and the rest of the drivetrain 46 are the same as in the first embodiment. In this embodiment, the accessory drive mechanism 148 may change its drive ratio to handle additional load from more than one accessory. The accessory input shaft 154 now connects not only to the clutch 56 of the first accessory 58, but also is coupled to the input of a second accessory drive mechanism 162. The output of this second accessory drive mechanism 162 is now coupled to a second accessory input shaft 164, which is coupled to a second vehicle accessory 166. The particular drive ratios of the first accessory drive mechanism 148 and the second accessory drive mechanism 162 may be varied according to the torque and rotational velocity requirements of the two accessories.

While there is no accessory clutch shown for this second accessory 166, it may also employ one, if so desired, but this is not required. For example, if the first accessory 58 is an air conditioning compressor and the second accessory 166 is a water pump, and it is a cool day where no air conditioning is required, then the compressor clutch 56 can be disengaged, but the water pump 166 is still driven to cool the engine 22.

And, of course, while this embodiment illustrates only two accessories connected to the system, more than two accessories can be connected and driven off of the main rotor shaft. In fact, if so desired, one can couple the second accessory drive mechanism directly to the main rotor shaft, rather than coupling it through the first accessory drive mechanism. The reason for such a change may be for packaging of the components within the vehicle's engine compartment (not shown), or due to the differences in the speed and torque requirements of the particular vehicle accessories.

While certain embodiments of the present invention have been described in detail, those familiar with the art to which this invention relates will recognize various alternative designs and embodiments for practicing the invention as defined by the following claims.

What is claimed is:

1. A vehicle drive system comprising:
an engine having a crankshaft for outputting torque;
a motor/generator having a stator, and a rotor rotationally mounted within the stator, with the rotor including a main rotor shaft;
a first clutch coupled to the crankshaft on a first side and the main rotor shaft on a second side, for selectively coupling the engine crankshaft to the main rotor shaft;
a transmission, having a main input shaft;
a second clutch coupled to the main rotor shaft on a first side and the transmission main input shaft on a second side, for selectively coupling the main rotor shaft to the transmission input shaft;
an accessory input shaft;
an accessory drive mechanism coupled between the main rotor shaft and the accessory input shaft; and
a rotationally driven vehicle accessory coupled to the accessory input shaft.

2. The vehicle drive system of claim 1 wherein the vehicle accessory is an air conditioning system compressor.

3. The vehicle drive system of claim 2 further including an accessory clutch coupled between the accessory input shaft and the compressor.

4. The vehicle drive system of claim 3 wherein the accessory clutch is a one-way clutch and the transmission is a continuously variable transmission.

5. The vehicle drive system of claim 1 further including an accessory clutch coupled between the accessory input shaft and the vehicle accessory.

6. The vehicle drive system of claim 1 wherein the transmission is a continuously variable transmission.

7. The vehicle drive system of claim 1 further including a second accessory input shaft operatively engaging the main rotor shaft, and a second vehicle accessory coupled to the second accessory input shaft.

8. The vehicle drive system of claim 7 further including a second accessory drive mechanism coupled between the second accessory input shaft and the accessory input shaft.

9. The vehicle drive system of claim 7 further including an accessory clutch coupled between the accessory input shaft and the vehicle accessory.

10. The vehicle drive system of claim 9 wherein the vehicle accessory is an air conditioning system compressor, and the second vehicle accessory is one of a water pump, a vacuum pump, a power steering pump, an air pump, and an oil pump.

11. The vehicle drive system of claim 7 wherein the vehicle accessory is an air conditioning system compressor, and the second vehicle accessory is one of a water pump, a vacuum pump, a power steering pump, an air pump, and an oil pump.

12. The vehicle drive system of claim 1 wherein the accessory drive mechanism is a gear assembly.

13. The vehicle drive system of claim 1 wherein the accessory drive mechanism is a pulley and belt assembly.

14. The vehicle drive system of claim 1 wherein the accessory drive mechanism is a sprocket and chain assembly.

15. A vehicle drive system comprising:
an engine having a crankshaft for outputting torque;
a motor/generator having a stator, and a rotor rotationally mounted within the stator, with the rotor including a main rotor shaft;
a first clutch coupled to the crankshaft on a first side and the main rotor shaft on a second side, for selectively coupling the engine crankshaft to the main rotor shaft;
a transmission, having a main input shaft;
a second clutch coupled to the main rotor shaft on a first side and the transmission main input shaft on a second side, for selectively coupling the main rotor shaft to the transmission input shaft;
an accessory input shaft;
an accessory drive mechanism coupled between the main rotor shaft and the accessory input shaft; and
an air conditioning system compressor coupled to the accessory input shaft.

16. The vehicle drive system of claim 15 further including an accessory clutch coupled between the accessory input shaft and the compressor.

17. The vehicle drive system of claim 16 wherein the accessory clutch is a one way clutch.

18. The vehicle drive system of claim 15 further including a second accessory input shaft operatively engaging the main rotor shaft, and a second vehicle accessory coupled to and driven by the second accessory input shaft.

19. The vehicle drive system of claim 15 further including a second accessory drive mechanism coupled between the second accessory input shaft and the accessory input shaft.

20. A vehicle drive system comprising:
an engine having a crankshaft for outputting torque;
a motor/generator having a stator, and a rotor rotationally mounted within the stator, with the rotor including a main rotor shaft;
a first clutch coupled to the crankshaft on a first side and the main rotor shaft on a second side, for selectively coupling the engine crankshaft to the main rotor shaft;
a continuously variable transmission, having a main input shaft;
a second clutch coupled to the main rotor shaft on a first side and the transmission main input shaft on a second side, for selectively coupling the main rotor shaft to the transmission input shaft;
an accessory input shaft;
an accessory drive mechanism coupled between the main rotor shaft and the accessory input shaft; and
a rotationally driven vehicle accessory coupled to the accessory input shaft.
